(19) United States
(12) Patent Application Publication
(10) Pub. No.: US 2014/0188395 A1
(43) Pub. Date: Jul. 3, 2014

(54) SYSTEM AND METHOD FOR REMOVAL OF JITTER FROM SEISMIC DATA

(71) Applicant: CGG SERVICES SA, Massy Cedex (FR)

(72) Inventors: Gordon POOLE, East Grinstead (GB); Andrew MORCOS, Three Bridges (GB)

(73) Assignee: CGG SERVICES SA, Massy Cedex (FR)

(21) Appl. No.: 14/138,397

(22) Filed: Dec. 23, 2013

Related U.S. Application Data
(60) Provisional application No. 61/748,270, filed on Jan. 2, 2013.

(51) Int. Cl. G01V 1/36

(52) U.S. Cl. CPC G01V 1/364
USPC 702/17

(57) ABSTRACT

A system and method are provided for reducing jitter in collected seismic data. The collected seismic data includes both original seismic data, e.g., original traces, and other seismic data, e.g., interpolated traces. The collected seismic data is filtered to form filtered seismic data, and then the original seismic data is re-inserted into the filtered seismic data. Filtering is repeated on the result based, for example, on one or more filter thresholds that progressively relax constraints on the filtering process, until the filtered data can be combined with the original seismic data with a good fit or a predetermined, e.g., user determined, number of times.

### PRIORITY INFORMATION

The present application claims priority under 35 U.S.C. §119(e) to U.S. Provisional Patent Application Ser. No. 61/748,270, filed Jan. 2, 2013, the entire contents of which are expressly incorporated herein by reference.

### TECHNICAL FIELD

The embodiments relate generally to signal processing of seismic data signals and more specifically to systems and methods for reducing and/or removing jitter in seismic data signals during seismic signal processing.

### BACKGROUND

Seismic waves generated artificially have been used for more than 50 years to perform imaging of geological layers. During seismic exploration operations, vibrator equipment (also known as a “source”) generates a seismic signal that propagates in the form of a wave that is reflected at interfaces of geological layers. These reflected waves are received by geophones, or more generally receivers, which convert the displacement of the ground resulting from the propagation of the waves into an electrical signal which is recorded. Analysis of the arrival times and amplitudes of these waves make it possible to construct a representation of the geological layers on which the waves are reflected.

FIG. 1 depicts schematically a system 100 for transmitting and receiving seismic waves intended for seismic exploration in a marine environment. System 100 comprises a source 118 on a streamer or cable 116a, pulled from ship or boat 102, on the surface 106 of ocean 108 (or other water mass, such as a large lake or river). Source 118 is operable to generate a seismic signal. System 100 further includes a set of receivers 120 (e.g., hydrophones) for receiving a seismic signal and converting it into an electrical signal, also located on streamer 116b, and marine seismic data recording/processing system 126 for recording and processing the electrical signals generated by receivers 120. Streamers 116 can also include birds 122 for guiding and maintaining position of streamers 116. Source 118, receivers 120 can be intermixed on one or more streamers 116, in any order. FIG. 1 depicts source 118 as a single source but it should be understood that the source may be composed of several sources, as is well known to persons skilled in the art. Also part of system 100 are antennas 124 that can be used to transmit information and controls between ships 102, land bases, birds 122 (some birds 122 can also include antennas 122) and other devices.

In operation, source 118 is operated so as to generate a seismic signal. This signal propagates through water 108, in the form of transmitted waves 124 that generate reflected waves 126 when they reach an interface 110 between two layers 108 (ocean) and 112 (a geological layer, in this case, the ocean floor; it can also be appreciated by those of skill in the art that sometimes the transmitted waves 124 travel upwards instead of downwards, and when they reach the interface between atmosphere/air 104 and ocean 108 (i.e., at ocean surface 108) downward reflected waves 126 can also be generated (not shown); these are known by those of skill in the art as “ghosts”). Each receiver 120 receives one or more reflected waves 126 and converts them into an electrical signal. System 200 intends to image the subsurface regions 112 to determine the presence, or not, of hydrocarbon deposit 114.

FIG. 2 depicts schematically a system 200 for transmitting and receiving seismic waves intended for seismic exploration in a land environment. System 200 comprises a source 202 consisting of a vibrator operable to generate a seismic signal, a set of receivers 204 (e.g., geophones) for receiving a seismic signal and converting it into an electrical signal and land seismic data recording/processing system 226 for recording and processing the electrical signals generated by receivers 204. System 200 can further include antennas 124 for communications between vehicles 226, receivers 204, and land seismic data recording/processing system 226.

Source 202, receivers 204 and land seismic data recording/processing system 226 (located on vehicle 226) are positioned on the surface of ground 208. FIG. 2 depicts source 202 as a single vibrator but it should be understood that the source may be composed of several vibrators, as is well known to persons skilled in the art. In operation, source 202 is operated so as to generate a seismic signal. This signal propagates firstly on the surface of the ground, in the form of surface waves 210, and secondly in the subsoil, in the form of transmitted waves 212 that generate reflected waves 214 when they reach an interface 220 between two geological layers. Each receiver 204 receives both surface wave 210 and reflected wave(s) 214 and converts them into an electrical signal, which signal thus includes a component associated with reflected wave 214 and another component associated with surface wave 210. Since system 200 intends to image the subsurface regions 216 and 218, including hydrocarbon deposit 214, the component in the electrical signal associated with surface wave 210 is undesirable and should be filtered out.

There are certain problems, however, with processing the data accumulated with both marine and land based seismic exploration systems. While great care can be taken to put receivers in as many locations, and certainly the best locations, it is not always technically feasible, nor economical to have as many receivers in as many locations as one might prefer. As a result, in order to obtain linear or consistent data throughout the test area, or geographical area of interest (GAI), it is necessary to interpolate the data between the known data collection points. Interpolation methods, however, range from crude, rough estimates (e.g., simple averages), to much more sophisticated methods. Nonetheless, however, sometimes the results leave much to be desired.

In other cases, interpolation of regularly sampled seismic data is often applied on processing projects to reduce aliasing prior to de-multiple processing, (e.g., Radon de-multiple, SRME, among other types) as well as at other stages in the processing. Interpolation is of particular use in time-lapse processing where differences in shot-spacing between different vintages need reconciling. As mentioned above, many data interpolation schemes are available, each having their own unique limitations. Several examples are discussed below.

A first example can be referred to as frequency-wavenumber (FK) interpolation using Fast Fourier Transforms (FFT) (or it's time domain equivalent, sync interpolation). F-K interpolation requires regularly sampled data, and generally does not work correctly for aliased data. Another example is frequency-distance (FX) interpolation (see, Spitz, S., 1991, “Seismic Trace Interpolation in the F-X domain,” Geophysics, 56, 785-796.). FX interpolation also requires regularly sampled data, but can interpolate beyond aliasing. A third examples is distance-time (XT) interpolation (see, Abma, R., 1995, “Least-squares Separation of Signal and Noise with Multidimensional Filters,” PhD thesis, Stanford University). A fourth example is “Beyond aliasing FK interpolation” (see, U.S. Pat. No. 5,617,372, to Gulunay, N. et al., “Un-aliased Spatial Trace Interpolation in the F-K domain,” and Gulunay, N., 2003, “Seismic Trace Interpolation in the Fourier Transform Domain,” Geophysics, 68, 355-369). The method prescribed by Gulunay, et al., also requires regularly sampled data, but can interpolate beyond aliasing. Another example is performing FX interpolation of empty bins in a binned dataset. A sixth example is minimum weighted norm interpolation (MWNI) (see, Liu, B. et al., 2004, “Minimum Weighted Norm Interpolation of Seismic Records,” Geophysics, 69, 1560-1568). MWNI fills empty bins in a binned dataset, and uses model weighting and the irregular sampling of input data to interpolate beyond aliasing. Still further there is “Projection on Convex Sets” (POCS) interpolation (see, U.S. Pat. No. 8,103,453 to Abma, R., “Method of Seismic Data Interpolation by Projection on Convex Sets”); The POCS method also fills empty bins in a binned dataset, uses model weighting and the irregular sampling of input data to interpolate beyond aliasing. Finally, there is anti-leakage Fourier transform (see, Xu, S. et al., 2005, “Antileakage Fourier Transform for Seismic Data Regularization,” Geophysics, 70, V87-V95.). The Anti-leakage method interpolates fully irregular data.

The above interpolation methods may be combined to achieve optimal results. For example, FK interpolation can be used for low temporal frequencies where the data is not aliased and the high frequencies can be interpolated with FX interpolation.

While results often looks good in the domain the interpolation has been applied, when the data is sorted to another domain, shortcomings in the interpolation can be observed as jitter. Jitter as used herein describes a pattern observed in the data where the interpolated traces have a slightly different character than the original traces. Jitter is undesirable as it represents discrete steps in the data that makes the results of processing less predictable and linear. Jitter shows up in displayed image data in the form of time shifts, amplitude changes, among other ways.

Other sources of jitter can also be identified. Interleaving of baseline and monitor data from a time lapse project can exhibit jitter due to different acquisition configurations between the data. Also in time-lapse projects we can have areas of under-shoot acquisition to image under an oil well which can exhibit jitter relative to the rest of the survey shot in conventional narrow azimuth format. In addition some processing projects involve the merging of more than one datasets. In the case that the surveys have been acquired with different source configurations, streamer separation, shooting direction, or other acquisition parameters, jitter can be observed in areas where the surveys overlap. We can see jitter between different acquisition azimuth directions in multi-azimuth acquisition or tiles in a wide azimuth acquisition. Alternatively when we merge ocean bottom seismic (OBS) and towed streamer data, jitter can be observed post migration relating to the difference in acquisition datum. Another example of jitter can relate to interference noise or crosstalk (simultaneous shooting) noise that may affect the data in a 2:1 or n:1 pattern. The pattern may not be strictly n:1 in this case as the traces containing interference or cross-talk noise may not follow the pattern. However, it will be the case that some traces or trace segments may be flagged as containing the noise whereas other traces or trace segments are not. In fact, there can be many datasets at different stages in the processing sequences which can be input to this method.

Existing methods filter the data to reduce the effect of jitter. Some examples include frequency filtering, FK filtering, FX filtering (see, Canales, L. L., 1984, “Random Noise Reduction,” 54th Annual International Meeting, SEG, Expanded Abstracts Session:S10.1.), filtering in the tau-p domain, Radon transform, among other methods. All of these methods also modify the input traces which is undesirable.

Accordingly, it would be desirable to provide methods, modes and systems for reducing or substantially eliminating jitter and the effects of jitter when filtering interpolated data, or even non-interpolated data that does not also modify reference traces (i.e., the original data).

### SUMMARY

An aspect of the embodiments is to substantially solve at least one or more of the problems and/or disadvantages discussed above, and to provide at least one or more of the advantages described below.

It is therefore a general aspect of the embodiments to reduce jitter in seismic data by iteratively filtering the seismic data using different filtering parameter(s). The filtering can be performed, e.g., a user-determined number of times or until the filtered seismic data fits with the original seismic data.

According to an embodiment, a method for reducing jitter in a seismic dataset which contains both original seismic data and other seismic data includes the steps of filtering said seismic dataset to generate a filtered seismic dataset; re-inserting the original seismic data into the filtered seismic dataset to generate a combined seismic data set; and repeating said filtering step and said re-inserting step on said combined dataset. According to another embodiment, a system for reducing jitter in a seismic dataset which contains both original seismic data and other seismic data includes an input device configured to receive the seismic dataset; and one or more processors configured to filter the seismic dataset to generate a filtered seismic dataset and to re-insert the original seismic data into the filtered seismic dataset to generate a combined seismic data set, wherein the one or more processors are further configured to repeat the filtering and the re-inserting on the combined dataset.

According to another embodiment, a method for reducing jitter in a seismic dataset which contains both original seismic data and other seismic data, includes the steps of filtering the seismic dataset to generate a filtered seismic dataset, re-inserting the original seismic data into the filtered seismic dataset to generate a combined seismic data set; and repeating the filtering step and the re-inserting step on the combined dataset until the other seismic data fits with the original seismic data, wherein the step of filtering further comprises: transforming the seismic dataset from a distance-time (XT) domain to a frequency wavenumber (FK) domain; creating a dip map by scanning dips in the seismic dataset to create a plurality of wavenumbers KD that respectively correspond to the FK transformed seismic dataset; using the dip map to eliminate certain FK transformed seismic data on the basis of respective corresponding wavenumbers KD; and reverse transforming remaining FK transformed seismic data back to the XT domain.

### BRIEF DESCRIPTION OF THE DRAWINGS

The above and other objects and features of the embodiments will become apparent and more readily appreciated from the following description of the embodiments with reference to the following figures, wherein like reference numerals refer to like parts throughout the various figures unless otherwise specified, and wherein:

FIG. 1 illustrates a side view of a marine seismic exploration system for use in an underwater seismic gathering process;

FIG. 2 illustrates a side view of a land seismic exploration system;

FIG. 3 illustrates a general method for seismic exploration according to an embodiment;

FIG. 4 illustrates a method for substantially reducing or eliminating jitter in seismic data following data acquisition and possible filtering and/or interpolation according to an embodiment;

FIG. 5 illustrates a method for substantially reducing or eliminating jitter in seismic data following data acquisition and possible filtering and/or interpolation according to an embodiment;

FIG. 6 illustrates a marine seismic data acquisition system suitable for use to implement a method for substantially reducing or eliminating jitter in seismic data following data acquisition and possible filtering and/or interpolation according to an embodiment;

FIG. 7 illustrates a land seismic data acquisition system suitable for use to implement a method for substantially reducing or eliminating jitter in seismic data following data acquisition and possible filtering and/or interpolation according to an embodiment; and

FIG. 8 is a flowchart illustrating a method for reducing jitter according to another embodiment.

### DETAILED DESCRIPTION

The concepts associated with these embodiments are described more fully hereinafter with reference to the accompanying drawings, in which embodiments are shown. In the drawings, the size and relative sizes of layers and regions may be exaggerated for clarity. Like numbers refer to like elements throughout. These concepts may, however, be embodied in many different forms and should not be construed as limited to the embodiments set forth herein. Rather, these embodiments are provided so that this disclosure will be complete, and will convey the scope of these concepts to those skilled in the art. The scope of the embodiments is therefore defined by the appended claims. The following embodiments are discussed, for simplicity, with regard to a method for filtering received data when using a cross spread source-receiver design for the acquisition of land based seismic data. However, the embodiments to be discussed next are not limited to a land based seismic acquisition, but may be applied to other systems that conventionally involved 3D fk filtering of acquired seismic data. Reference throughout the specification to “one embodiment” or “an embodiment” means that a particular feature, structure, or characteristic described in connection with an embodiment is included in at least one embodiment of the present embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

According to embodiments, the problems described above can be addressed by, for example, a system and method for reducing jitter in collected seismic data. Original seismic data is collected, then partitioned or divided into reference original seismic data and original seismic data to be modified, and then re-combined to form combined seismic data. The combined seismic data is then filtered to form filtered seismic data to be modified. Filtering is repeated on the basis of a plurality of filter thresholds that progressively relax constraints on the filtering process, until the filtered data can be combined with the original seismic data. This process may stop following a defined number of iterations, on the basis of cross correlation values exceeding certain threshold levels, which cross correlation values are impacted by the filtering.

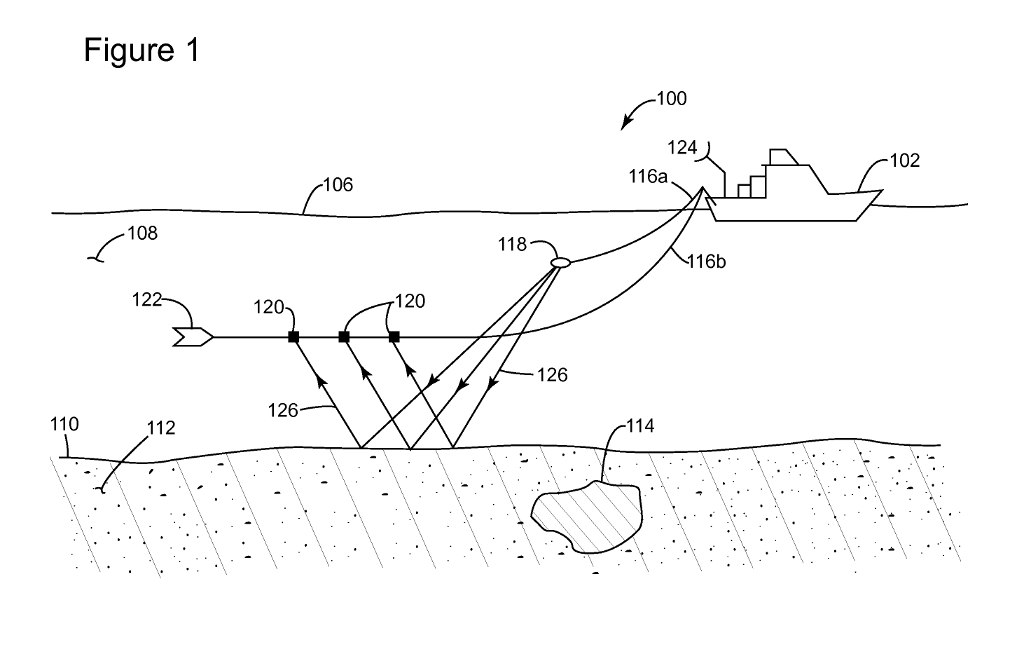

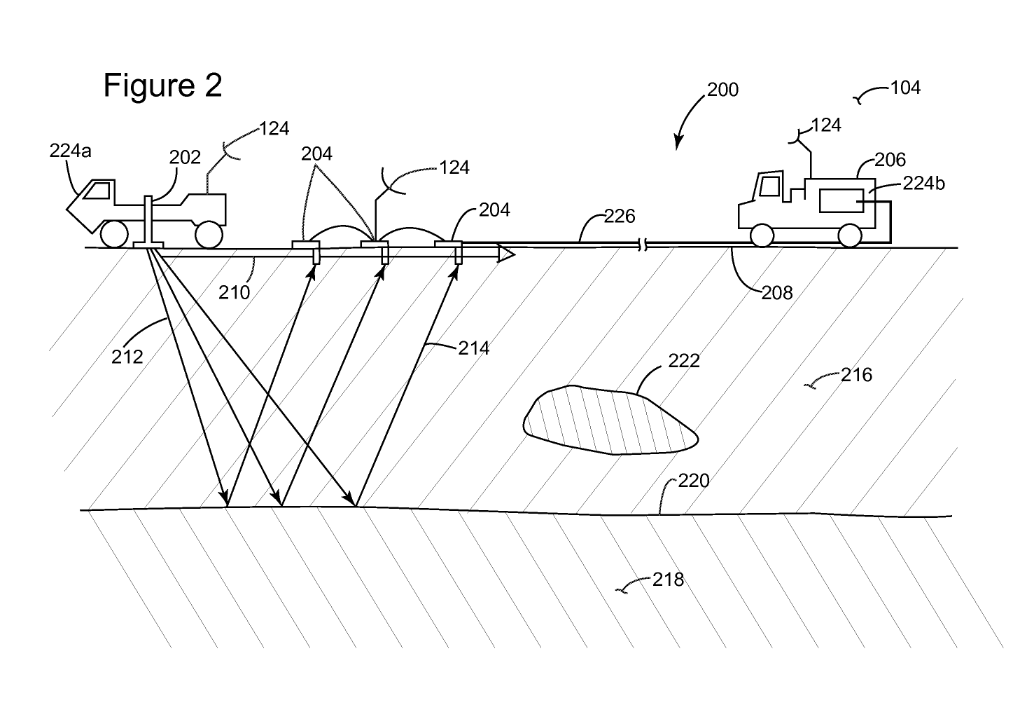

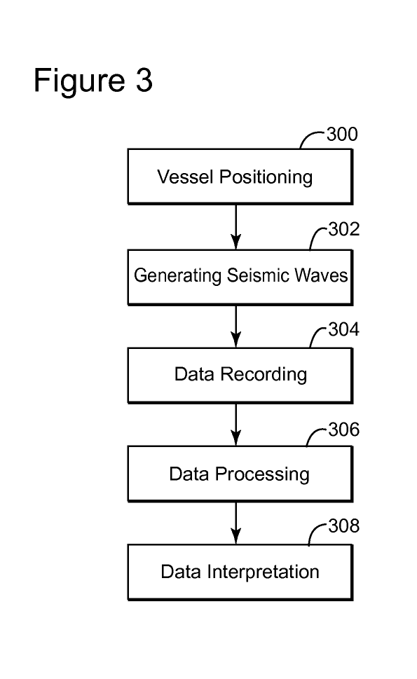

Prior to discussing such filtering embodiments in more detail, it may be useful to consider the overall seismic exploration process in general for context. As generally discussed above, one purpose of seismic exploration is to render the most accurate graphical representation possible of specific portions of the Earth's subsurface geologic structure, e.g., using the seismic data which is collected as described above with respect to FIG. 1 (and FIG. 2, in a land embodiment/marine embodiment). The images produced allow exploration companies to accurately and cost-effectively evaluate a promising target (prospect) for its oil and gas yielding potential (e.g., hydrocarbon deposits 120). FIG. 3 illustrates a generalized method for seismic exploration that includes both the acquisition of the seismic data described above, and the subsequent processing of that seismic data to form such images. In FIG. 3, the overall process is broken down into five steps, although one could of course characterize seismic exploration in a number of different ways. Step 302 references the initial positioning of the survey equipment in the geographic area of interest (GAI) and the preparation to begin surveying the GAI in a manner which is precise and repeatable. Seismic waves are generated by the afore-described sources or vibrators (step 304), and data recording is performed on the reflected, scattered and surface waves by the receivers (step 306). In step 308, processing of the raw, recorded seismic data occurs. Data processing generally involves numerous processes intended to, for example, remove noise and unwanted reflections from the recorded data and involves a significant amount of computer processing resources, including the storage of vast amounts of data, and multiple processors or computers running in parallel. In particular, for the embodiments discussed below, such processing includes filtering to remove scattered waves. Such data processing can be performed on site, back at a data processing center, or some combination thereof. Finally, in step 310, data interpretation occurs and the results can be displayed or generated as printed images, sometimes in two-dimensional form, more often now in three dimensional form. Four dimensional data presentations (i.e., a sequence of 3D plots or graphs over time) are also possible outputs, when needed to track the effects of, for example, extraction of hydrocarbons from a previously surveyed deposit.

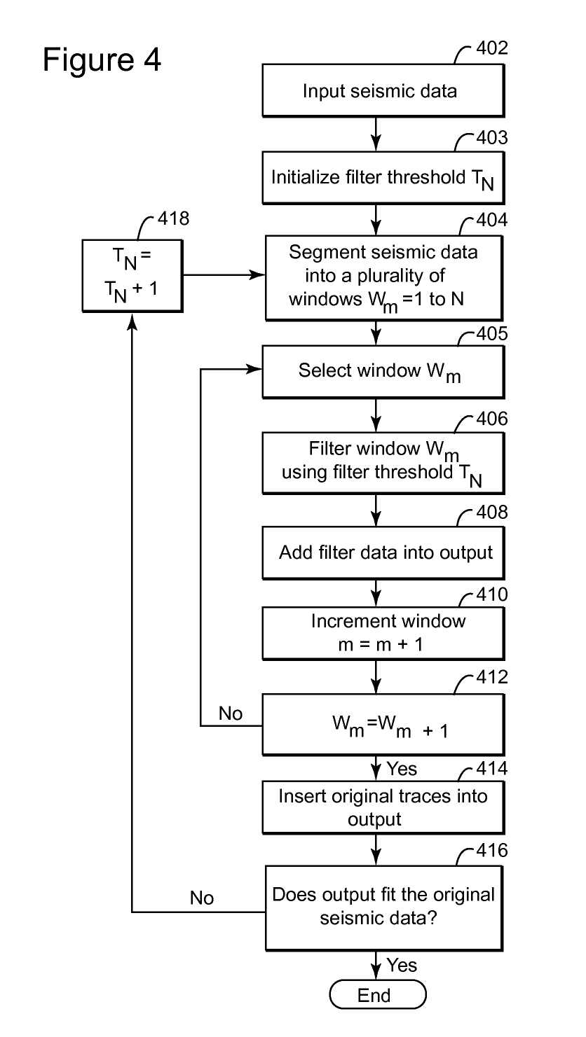

With this context in mind, FIG. 4 illustrates a flow chart of method 400 for substantially reducing or eliminating jitter in seismic data following data acquisition and possible filtering and/or interpolation according to an embodiment. First, in step 402 a seismic dataset is input. The seismic dataset input at step 402 will have two or more components (resulting in jitter), which are generally referred to herein as “original” or “reference” seismic data, and “other” seismic data. In one embodiment the original or reference data is data associated with actual traces recorded during a seismic acquisition, e.g., a trace associated with a source and a receiver. In this embodiment, then, the other seismic data can, for example, be data associated with interpolated traces. However, as will be described in more detail below, the present invention is not limited to reducing jitter in seismic datasets having different sets of traces, but can be implemented to reduce jitter in numerous other types of seismic datasets, e.g., different vintages, different surveys, different offset classes, seismic interference noise, simultaneous shooting noise, etc. Regardless of the type of seismic data being processed, the distinction between original seismic data and other seismic data is useful in the embodiments to identify which seismic data to replace or re-insert into the composite seismic data set.

Returning to FIG. 4, the filter threshold T_{N} is initialized in step 403 (filter thresholds or parameters are discussed in more detail below). At step 404, the seismic dataset can optionally be separated or segmented into temporal/spatial windows, though that need not necessarily be the case, i.e., step 404 is optional.

Following optional window segmentation in step 404, and assuming that the seismic data is segmented into a plurality of windows, a window is selected (step 405) and the seismic dataset can then be filtered, in step 406, using a first set of filter parameters, e.g., filter threshold T_{N}, to produce filtered seismic data. In a first embodiment, the filter type involves FK filtering, so the first set of filter parameters can be, according to an embodiment, based on the relative strength and weakness of the wavenumbers. According to a further embodiment, described below, when the method filters the seismic data, it can also perform an optional step of transforming the seismic data from a first domain to a second domain. Presuming, according to an embodiment, that transformation into the FK domain is desired, the windows contain linear events. According to an embodiment, each window can be delineated into time periods of 500 milliseconds or so in the vertical axis, and 1000 meters or so in the horizontal axis.

Once this window of data has been filtered, it can be added into an output for this iteration of the process, i.e., merged back with other already filtered blocks at step 408. The merging may be in the form of linear, cosine, or other spatial and or temporal taper functions. This process can be continued via the loop described by steps 405-412 until all of the data in the input seismic dataset has been processed. Then, the original traces from the seismic data set can be re-inserted into the output at step 414.

Next, in decision step 416, a determination is made as to whether the filtered seismic data, i.e., the current output, fits with the original seismic data. According to an embodiment, a first data set “fits in” with in a second data set when the normalised cross-correlation between the first data set and the second data set exceeds a user defined or predetermined level. According to an embodiment, by way of non-limiting example only, one such cross correlation value can be 0.7. Alternatively the process may simply be repeated a user defined number of times. If the filtered seismic data does not fit in with the original seismic data (“No” path from decision step 416), then method 400 proceeds to step 418, wherein the filter threshold T_{N} is incremented, and steps 404-416 are performed again, with different filter threshold(s), until the filtered seismic data does fit in with the original seismic data (“Yes” path from decision step 416) and the resulting, filtered seismic dataset is then output.

After the process 400 ends, additional processing can occur or the data can be displayed. As discussed above in regard to decision step 416, according to an embodiment, the filtering process repeats if the two sets of data do not fit, except that in the following iteration, the filter parameters are relaxed; the purpose of the relaxation of the filter parameters is to combine, or “blend” the reference original seismic data and the retained filtered combined seismic data such that jitter and/or discontinuities are substantially reduced or eliminated, especially when transforming the data into the domain of the filter type. As discussed above, the process can be repeated on a window-by-window basis, or not, and the number of filter parameters can be set by the user based on empirical determinations, or in consideration of physical constraints of time and processing costs. According to further embodiment, on each subsequent pass of filtering, the image data begins to take on more definitive appearance; that is, after a first pass, according to an embodiment, the interpolated traces might appear smeared or synthetic looking. However, according to an embodiment of the method, the correct dips would be evident, even after only the initial pass, and consequently whatever energy was contained in those dips would fit in approximately with the original traces. Each subsequent iterative pass creates better looking data, as the filter constraint is relaxed, and the image becomes less and less synthetic looking, and exhibits greater and greater detail, such that is “meshed” with the original data.

According to other embodiments, the method of FIG. 4 can be modified by performing the filtering step 406 in a different, model domain than the domain of the input seismic data 402. For example, prior to step 406, the data can be transformed from an original domain into another domain. The another domain can be any desired domain including, but not limited to, fx domain (e.g. fx deconvolution, fx projection filtering, rank reduction filtering, fp thresholding), tK domain, FK domain, tau-p domain, parabolic radon domain, hyperbolic radon domain, curvelet domain, image domain, wavelet domain, etc. In such embodiments, the flow of FIG. 4 would be modified as follows. First, prior to step 406, another step would be inserted to transform the data into the selected model domain. Second, step 406 would be performed by filtering the data in the selected model domain. Third, after step 406, another step would be inserted to reverse transform the data from the model domain into the original domain. The windowing and filtering may also be applied in higher dimensional space, e.g. (x,y,t), (shot-x,shot-y,receiver-x,receiver-y), (x,y,offset), (x,y,offset-x,offset-y). In the embodiment described in FIG. 4, all blocks are iteratively filtered the same number of times. It will often be the case that some processing windows do not need filtering as much as others. When this is the case, the number of filtering iterations be defined on a block by block basis.

According to an embodiment, the filtering approach disclosed herein can be designed to isolate the character of the main data from the jitter; that is, a comparison is made of the original and interpolated data and differences are noted. It is as these points where the data filtered according to an embodiment of the method can be most noticeable. As such, following each iteration the aggressiveness of the filter can be relaxed as the level of jitter reduces. This results in the character of the modified traces slowly being refined to fit in more-and-more with the reference original seismic data. As mentioned above, the number of iterations is set by a user; it can change regularly, or irregularly, from iteration-to-iteration, or can follow a pattern, or none at all. In other cases, according to further embodiments, the filter type can change from iteration-to-iteration.

According to one embodiment, the method is not directly used for interpolation or as a means of interpolating, but can be used to repair interpolation shortfalls. According to a further embodiment, the method can be used in place of interpolation. The use of the method is not limited to interpolation but can be used in other instances where jitter is observed in data. According to another embodiment discussed herein, method 500 for reduction of jitter is employed in the common mid-point (CMP) domain following FX interpolation in the receiver domain. Method 500 according to an embodiment can be applied in any domain where jitter is observed, and can be extended to higher dimensions, e.g. 3D in the common offset IL-XL-Time domain, common shot domain, 5D in the IL-XL-OFFX-OFFY-Time domain, etc.

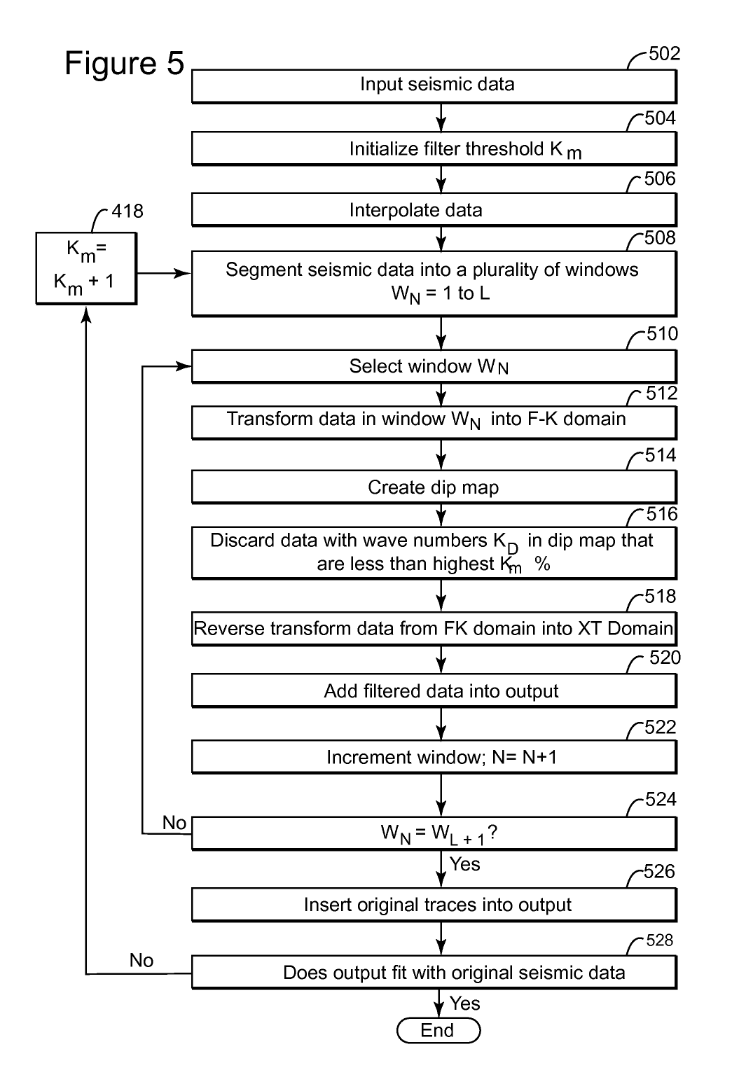

Turning now to FIG. 5, method 500, as shown in FIG. 5, is illustrated in flow-chart form, and as such is described in a manner of performing a method as in a software program for ease of understanding. As those of skill in the art can further appreciate, when performing such process steps in an apparatus as discussed in greater detail below, one or more of the “flow-chart” steps may not necessarily need to be performed and yet the method as described can still function to achieve the desired result that it is to substantially reduce or eliminate jitter from data that may or may not include interpolation results. In method 500, therefore, the number of windows that seismic data will be segmented into is defined as W; the number of filter thresholds per window is defined as T; N is designated as the window counter; and M is designated as the filter threshold (hereinafter referred to as “threshold”) counter.

In step 502 seismic data is collected in, e.g., the XT domain and defined as original reference seismic XT data. As those of skill in the art can appreciate, there are numerous processes that can be applied to seismic data after it is collected by receivers 14. Thus, in this context, the phrase “original reference seismic XT data” simply means that the data has not been yet processed by method 500, as opposed to the data that is output by method 500. According to a further embodiment, seismic data can be acquired from at least one of (a) two vintages from a time lapse survey, (b) different azimuths of a multi-azimuth acquisition, (c) two or more surveys that are to be merged, (d) data after interpolation, (e) data contaminated by interference noise, (f) data contaminated by cross-talk noise and (g) any other dataset wherein the original seismic data includes reference original seismic data and original seismic data to be modified such that jitter can be observed between said reference original seismic data and original seismic data to be modified. Still further according to an embodiment, acquiring original seismic data can include acquiring original seismic data from at least one of a towed streamer, ocean bottom survey, and land survey. According to a further embodiment, acquiring original seismic data can include acquiring original seismic data from at least one of a hydrophone, geophone, particle velocity sensor, and accelerometer.

At step 504, the filter threshold K_{M} is initialized and in step 506 the original reference seismic XT data is interpolated, using one or more of the conventional interpolation techniques as discussed above to form interpolated seismic XT data. However, as those of skill in the art can appreciate, data does not have to be interpolated for it to have or contain jitter, as jitter can arise from base/monitor datasets, different azimuths, survey merges, among other sources. Thus, whether the collected reference seismic XT data contains jitter from an interpolation process or from some other means, the data is referred to as original reference seismic XT data.

The next step in method 500 is step 508, wherein both original reference seismic XT data and interpolated seismic XT data is segmented into W spatial/temporal windows, still in the XT domain. This data is now known as Original Reference Seismic XT Data Window_{(N)} and Interpolated Seismic XT Data Window_{(N)}, where N ranges from 1 to W, meaning that there are now W windows of Original Seismic Data and W windows of interpolated Seismic Data. As discussed above, the segmenting of data into windows is optional, and the window size can be determined beforehand based on the amount of data collected, processing capabilities, among other items of concern. As will be seen in the Figure, step 508 also begins the outer loop of processing according to method 500.

In step 510, a window of data is selected for processing in the inner loop. As such, method 500 is presented as a loop within a loop, in that for each window, the original and interpolated data, as described below, will be iteratively subjected to filter parameters that change, if necessary, for each iteration from more stringent to more relaxed over each iteration. Following iteration of the filter parameters in a first window, method 500 proceeds to perform the same iterative process on the data in a second window, then third, and so on until all of the original and interpolated data has been iteratively processed by the particular filter used according to an embodiment. Further, method 500 can change the filter parameters from window-to-window, as well as change the filter type within each window, or from window-to-window. Further still, according to an embodiment, segmentation of original seismic XT data into windows is optional, as discussed above.

Following method step 510, method 500 proceeds to step 512 wherein the data is transformed into from the XT domain into the FK domain, wherein, in the FK domain, F is equal to frequency, and K is defined as the wave number.

In step 514, a dip map is created by scanning the transformed data in the window being processed for dips. This is equivalent to summing energy for each slowness trace in the amplitude frequency-slowness (FP) domain. As those of skill in the art can appreciate, dips show the steepest angle of descent of a tilted bed or feature relative to a horizontal plane, and can be generally characterized by a number ranging from 0° to 90°, as well as a letter (north (N), south (S), east (E), west (W)) that shows the general or average direction in which the bed or layer is dipping. More commonly, the dips may be defined as an event slowness in s/m. According to an embodiment, a plurality of wavenumbers K_{D} that correspond to the windowed data are created. The dip map may be derived using all frequencies, un-aliased frequencies, or frequencies relating to strong signal-to-noise ratio.

In step 516, the wave numbers K_{D} in the dip map are evaluated with respect to K_{M}, which is the wavenumber filter threshold value for this particular iteration of method 500, That is, for a first iteration, in which M equals 1, the first threshold value, K_{I}, is retrieved. According to an embodiment, K_{M} represents a percentage; then, all of the K_{D} wave numbers of this iteration of method 500 are sorted and ranked from lowest to highest; only the data associated with the highest K_{M} percentage are retained, and the rest of the data is discarded. That is, for purposes of example only, suppose K_{M} equals 2%; then, all of the data associated with the wavenumbers K_{D} that are not in the top 2% will be discarded.

According to an embodiment, the first threshold value for the wave numbers could be set fairly strictly, such as, for example, taking only the strongest 2%. This means that unless the wave number is in the top 2% of the values the data associated with the respective wave number will be discarded in step 516. Thus, the result of step 516—in the first iteration—is a set of seismic data that is associated with or comprises the strongest 2% of the wavenumbers. After the “weaker” wave number data values are eliminated, what remains is referred to as Seismic Filter FK Output Data_{(N,M)}. For successive iterations of method 500, if they prove necessary, the threshold values K_{M} are relaxed; that is, for example, in the second iteration instead of taking the strongest 2% of wavenumbers, according to an embodiment, the threshold value could be set so that the strongest 10% of the wavenumbers are retained, and the balance eliminated. In a third iteration the threshold value could be set such that the strongest 30% of wavenumbers are retained, and so on. According to an embodiment, both the number of threshold values and the threshold values themselves can vary and the examples discussed are non-limiting. Further, according to another embodiment, the type or method of iterative filtering can change, from one data set to another, or even within data sets. If a different iterative filtering process is used, the threshold values would change as well. Such filtering types can include at least frequency filtering, FX filtering, tau-p domain filtering, Radon transform filtering, among others. Different data sets, and desired data outputs can cause users to choose or select one filter type over another, or to combine filter types, along with their respective iterative constraints, accordingly.

Following step 516, in step 518, method 500 reverse transforms Seismic Filter FK Output Data_{(N,M)} from the FK domain to the XT Domain, to obtain Seismic Filter XT Output Data_{(N,M)}. Then, at step 520, the filtered data associated with this pass is merged in with the other filtered data from other passes, i.e., in other windows. Steps 510-524 are repeated until all of the seismic data has been processed using this set of filtering thresholds as indicated by steps 522 and 524. Then, at step 526, the original traces from the input seismic data set are replaced or re-inserted into the filtered data set.

In decision step 528, a determination is made: does Seismic Filter XT Output Data_{(NM)} fit with Original Reference Seismic XT Data Window_{(N)}? The “fitting” determination is substantially similar to the “fitting” determination that was discussed above in regard to FIG. 4; According to an embodiment, a first data set “fits in” with in a second data set when the normalised cross-correlation between the first data set and the second data set exceeds a user defined level. According to an embodiment, by way of non-limiting example only, one such cross correlation value can be 0.7. If Seismic Filter XT Output Data_{(N,M)} does not fit in with Original Reference Seismic XT Data Window_{(N)} (“No” path from decision step 528), then method 500 proceeds to increment K_{M} by 1 and reset the window counter N, and the flow returns to step 508, to repeat steps 508-528, until either all of the filters M have been used, or the determination of step 528 is positive, meaning that Seismic Filter XT Output Data_{(N,M)} does fit in with Original Reference Seismic XT Data Window_{(N)}. In the case that Seismic Filter XT Output Data_{(N,M)} does fit in with Original Reference Seismic XT Data Window_{(N)} (“Yes” path from decision 530), method 500 ends and the fitted seismic data set is output, e.g., for further processing or as an image. In the embodiment described in FIG. 5, all blocks are iteratively filtered the same number of times. It will often be the case that some processing windows do not need filtering as much as others. When this is the case, the number of filtering iterations be defined on a block by block basis.

According to an embodiment, the original seismic data is not altered in any manner, and the filtered output is interleaved with the reference original data, i.e., reference original traces are replaced with modified traces, and that then becomes the complete and final output of method 500. The result of the iteratively constrained filtering process is to, in a step-like fashion, approach data values that reduce or substantially eliminate jitter between data points that arise to inherent limitations in the interpolation process.

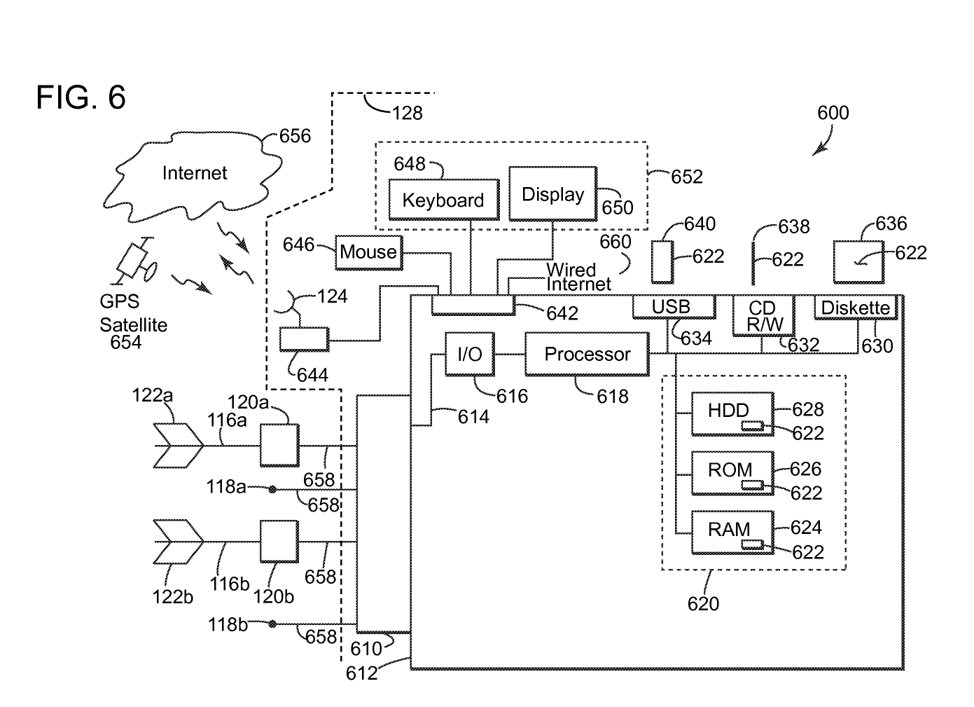

FIG. 6 illustrates marine seismic data collection system 600 suitable for use to implement method 500 for reducing jitter in acquired seismic data according to an embodiment. Marine seismic data collection system 600 includes, among other items, server 612, source/receiver interface 610, internal data/communications bus (bus) 614, processor(s) 618 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 634, compact disk (CD)/digital video disk (DVD) read/write (R/W) drive 632, floppy diskette drive 630 (though less used currently, many servers still include this device), and data storage unit 620.

Data storage unit 620 itself can comprise hard disk drive (HDD) 628 (these can include conventional magnetic storage media, but, as is becoming increasingly more prevalent, can include flash drive-type mass storage devices 640, among other types), ROM device(s) 626 (these can include electrically erasable (EE) programmable ROM (EEPROM) devices, ultra-violet erasable PROM devices (UVPROMs), among other types), and random access memory (RAM) devices 624. Usable with USB port 634 is flash drive device 640, and usable with CD/DVD R/W device 632 are CD/DVD disks 638 (which can be both read and write-able). Usable with diskette drive device 630 are floppy diskettes 636. Each of the memory storage devices, or the memory storage media (624, 626, 628, 636, 638, and 640, among other types), can contain parts or components, or in its entirety, executable software programming code (software) 622 that can implement part or all of the portions of the method described herein. Further, processor 618 itself can contain one or different types of memory storage devices (most probably, but not in a limiting manner, RAM memory storage media 624) that can store all or some of the components of software 622.

In addition to the above described components, marine seismic data acquisition system 600 also comprises user console 652, which can include keyboard 648, display 650, and mouse 646. All of these components are known to those of ordinary skill in the art, and this description includes all known and future variants of these types of devices. Display 650 can be any type of known display or presentation screen, such as liquid crystal displays (LCDs), light emitting diode displays (LEDs), plasma displays, cathode ray tubes (CRTs), among others. User console 652 can include one or more user interface mechanisms such as a mouse, keyboard, microphone, touch pad, touch screen, voice-recognition system, among other inter-active inter-communicative devices.

User console 652, and its components if separately provided, interface with server 612 via server input/output (I/O) interface 642, which can be an RS232, Ethernet, USB or other type of communications port, or can include all or some of these, and further includes any other type of communications means, presently known or further developed. Marine seismic data acquisition system 600 can further include communications satellite/global positioning system (GPS) transceiver device 644 (to receive signals from GPS satellites 654), to which is electrically connected at least one antenna 124 (according to an embodiment, there would be at least one GPS receive-only antenna, and at least one separate satellite bi-directional communications antenna). Marine seismic data acquisition system 600 can access internet 656, either through a hard wired connection, via I/O interface 642 directly, or wirelessly via antenna 124, and transceiver 644.

Server 612 can be coupled to other computing devices, such as those that operate or control the equipment of ship 102, via one or more networks. Server 612 can be part of a larger network configuration as in a global area network (GAN) (e.g., internet 656), which ultimately allows connection to various landlines.

According to a further embodiment, marine seismic data acquisition system 600, being designed for use in seismic exploration, will interface with one or more sources 118 and one or more receivers 120. These, as previously described, are attached to streamers 116 to which are also attached birds 122 that are useful to maintain positioning. As further previously discussed, sources 118 and receivers 120 can communicate with server 612 either through an electrical cable that is part of streamer 116, or via a wireless system that can communicate via antenna 124 and transceiver 644 (collectively described as communications conduit 658).

According to further embodiments, user console 652 provides a means for personnel to enter commands and configuration into marine seismic data recording/processing system 128 (e.g., via a keyboard, buttons, switches, touch screen and/or joy stick). Display device 650 can be used to show: streamer 116 position; visual representations of acquired data; source 118 and receiver 120 status information; survey information; and other information important to the seismic data acquisition process. Source and receiver interface unit 610 can receive the hydrophone seismic data from receiver 120 though streamer communication conduit 658 (discussed above) that can be part of streamer 116, as well as streamer 116 position information from birds 122; the link is bi-directional so that commands can also be sent to birds 122 to maintain proper streamer positioning. Source and receiver interface unit 610 can also communicate bi-directionally with sources 118 through the streamer communication conduit 658 that can be part of streamer 116. Excitation signals, control signals, output signals and status information related to source 118 can be exchanged by streamer communication conduit 658 between marine seismic data acquisition system 600 and source 118.

Bus 614 allows a data pathway for items such as: the transfer and storage of data that originate from either the source sensors or streamer receivers; for processor 618 to access stored data contained in data storage unit memory 620; for processor 618 to send information for visual display to display 652; or for the user to send commands to system operating programs/software 622 that might reside in either the processor 618 or the source and receiver interface unit 610.

Marine seismic data collection system 600 can be used to implement method 600 for jitter reduction in seismic data as described above according to various embodiments. Hardware, firmware, software or a combination thereof may be used to perform the various steps and operations described herein. According to an embodiment, software 622 for carrying out the above discussed steps can be stored and distributed on multi-media storage devices such as devices 624, 626, 628, 630, 632, and/or 634 (described above) or other form of media capable of portably storing information (e.g., universal serial bus (USB) flash drive 622). These storage media may be inserted into, and read by, devices such as the CD-ROM drive 632, disk drives 630, 628, among other types of software storage devices.

It should be noted in the embodiments described herein that these techniques can be applied in either an “offline”, e.g., at a land-based data processing center or an “online” manner, i.e., in near real time while on-board the seismic vessel. For example, data processing including jitter reduction according to method 400 can occur as the seismic data is recorded on-board seismic vessel 102. As also will be appreciated by one skilled in the art, the various functional aspects of the embodiments may be embodied in a computing device, as a method or in a computer program product. Accordingly, the embodiments may take the form of an entirely hardware embodiment or an embodiment combining hardware and software aspects. Further, the embodiments may take the form of a computer program product stored on a computer-readable storage medium having computer-readable instructions embodied in the medium. Any suitable computer-readable medium may be utilized, including hard disks, CD-ROMs, digital versatile discs (DVDs), optical storage devices, or magnetic storage devices such a floppy disk or magnetic tape. Other non-limiting examples of computer-readable media include flash-type memories or other known types of memories.

Further, those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and non-volatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or non-volatile memory such as read only memory (ROM) and/or random access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable and volatile/non-volatile computer storage media. For example, the processor can access a hard disk drive that reads from or writes to non-removable, non-volatile magnetic media, a magnetic disk drive that reads from or writes to a removable, non-volatile magnetic disk, and/or an optical disk drive that reads from or writes to a removable, non-volatile optical disk, such as a CD-ROM or other optical media. Other removable/non-removable, volatile/non-volatile computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertains.

The disclosed embodiments provide systems, computer software, and methods for jitter reduction in seismic data. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

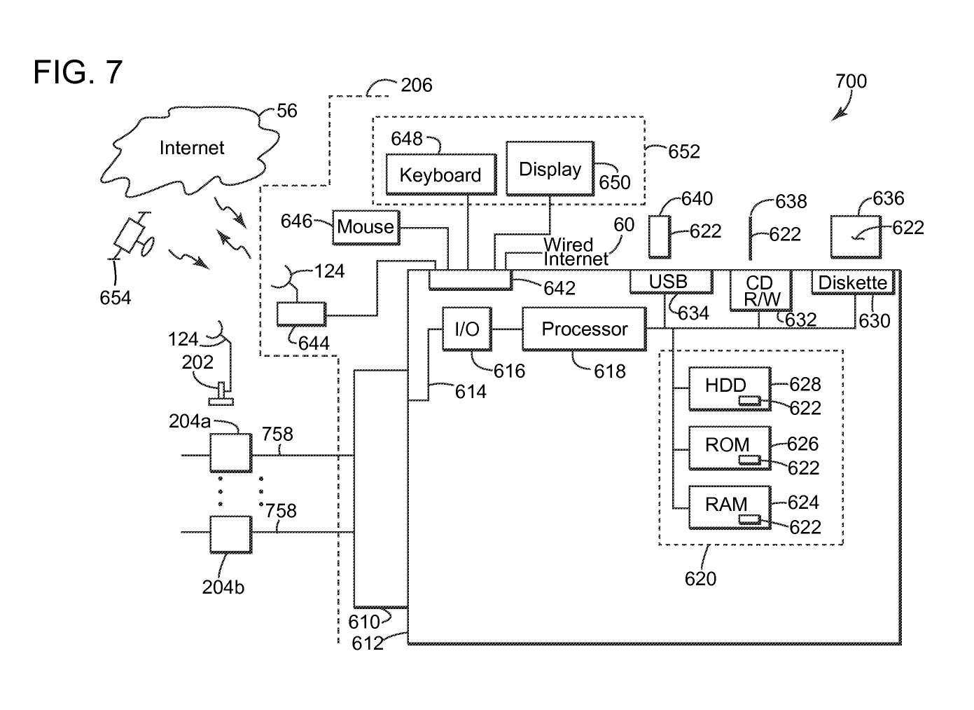

FIG. 7 illustrates a land seismic data acquisition system 700 suitable for use to implement method 400 or 500 for reducing jitter in acquired seismic data according to an embodiment. As those of skill in the art can appreciate, while the seismic data signals themselves can represent vastly different types of underground structure, and while the signal processing can, therefore, be vastly different as a consequence, the basic equipment remains essentially the same, and thus, FIG. 7 closely resembles FIG. 6 and includes many of the same components. As a result, in fulfillment of the dual goals of clarity and brevity, a detailed discussion of land seismic data acquisition system 700 will be omitted (as like objects in FIG. 7 have been referenced similarly to those in FIG. 6), other than to note that the source of the signal, source/vibrators 202, and receivers 204, communicate to source/receiver interface 610 via cable 226/758 that are similar to streamer 116/758 in terms of command, control and communications functions.

As briefly discussed above, method 500 for reducing jitter in acquired seismic data can be implemented in either or both of marine and land seismic data acquisition systems 600, and 700, respectively, as shown and described in reference to FIGS. 6 and 7. Further, it should be understood that marine seismic data acquisition system 600, and hence method 500 for reducing jitter in acquired seismic data, can be implemented in a marine seismic exploration system 100 as shown and described in reference to FIGS. 1 and 6. As such, all of the components shown and described in FIGS. 1 and 6 encompass all embodiments. Further, it should be understood that land seismic data acquisition system 700, and hence method 500 for reducing jitter in acquired seismic data, can be implemented in land seismic exploration system 200 as shown and described in reference to FIGS. 2 and 7. As such, all of the components shown and described in FIGS. 2 and 7 encompass all embodiments.

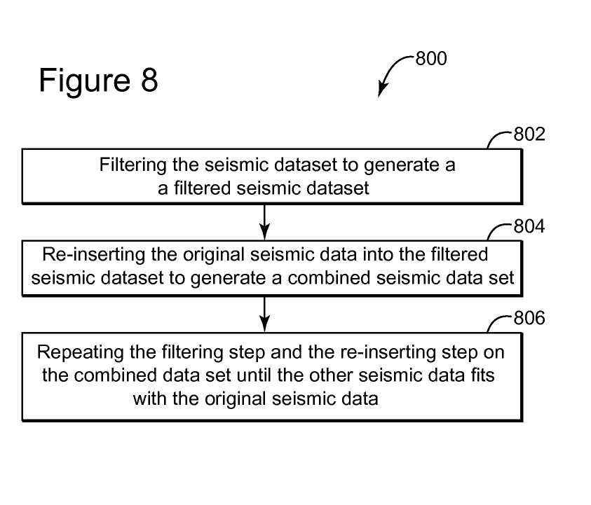

A more generalized embodiment, at least relative to FIGS. 4 and 5, is presented in the flowchart of FIG. 8. Therein, a method for reducing jitter in a seismic dataset which contains both original seismic data and other seismic data, includes a step 802 of filtering the seismic dataset to generate a filtered seismic dataset. At step 804, the original seismic data is re-inserted into the filtered seismic dataset to generate a combined seismic data set. Steps 802 and 804 are then repeated, e.g., one or more times as shown by step 806, until the other seismic data fits with the original seismic data using any desired fitness metric. Note that this repetition may be performed a fixed or predetermined number of times, e.g., 10 times, until it is expected that the other seismic data will fit with the original seismic data, or the repetition may be performed a variable number of times, e.g., checking after each iteration whether the fit is sufficiently close using the above-described cross-correlation.

Although the features and elements of the embodiments are described in the embodiments in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

We claim:

1. A method for reducing jitter in a seismic dataset which contains both original seismic data and other seismic data, the method comprising:
filtering said seismic dataset to generate a filtered seismic dataset;
re-inserting the original seismic data into the filtered seismic dataset to generate a combined seismic data set; and
repeating said filtering step and said re-inserting step on said combined dataset.

2. The method of claim 1, wherein the original seismic data is original traces and the other seismic data is interpolated traces.

3. The method of claim 1, wherein the original seismic data is data associated with a first seismic survey of an area and the other seismic data is data associated with a second seismic survey of the same area.

4. The method of claim 1, wherein the original seismic data is data associated with one of a vintage, a survey, an offset class or an azimuth class, and wherein the other seismic data is data associated with a respective one of another vintage, another survey, another offset class or another azimuth class.

5. The method of claim 1, wherein the jitter is associated with one of interference noise or simultaneous shooting cross-talk noise.

6. The method of claim 1, wherein the step of repeating said filtering and re-inserting is performed a predetermined number of times.

7. The method of claim 1, wherein the steps of filtering and re-inserting are repeated a variable number of times until the other seismic data fits with the original seismic data when a normalized cross-correlation between said filtered seismic dataset and said original seismic data exceeds a threshold level.

8. The method of claim 1, wherein the filtering is applied in a same domain as the seismic data set, and wherein the filtering is one of:
running average filtering along geological horizons, or time domain prediction filtering.

9. The method of claim 1, wherein the filtering is applied in a domain which is different to a domain of the seismic data set, and wherein the domain in which the filtering is performed is one of: fx domain, fp domain, tK domain, FK domain, tau-p domain, parabolic radon domain, hyperbolic radon domain, image domain, or curvelet domain.

10. The method according to claim 1, wherein the step of filtering comprises:
transforming said seismic dataset from a distance-time (XT) domain to a frequency wavenumber (FK) domain;
creating a dip map by scanning dips in said seismic dataset to create a plurality of wavenumbers K_{D} that respectively correspond to said FK transformed seismic dataset;
using said dip map to eliminate certain FK transformed seismic data on the basis of respective corresponding wavenumbers K_{D}; and
reverse transforming remaining FK transformed seismic data back to said XT domain.

11. The method according to claim 10, wherein said step of using said dip map comprises:
determining a relative value for each wavenumber K_{D} with respect to every other K_{D} wavenumber value, such that there are highest to lowest numbers of wavenumbers K_{D}; and
eliminating FK transformed seismic data that corresponds to those KD values that are not among the highest K_{T} percentage of the K_{D} wavenumber values, wherein K_{T} is one of a plurality of predetermined filter thresholds.

12. The method according to claim 10, wherein said step of using said dip map comprises:
binning each of said wavenumbers K_{D} according to an absolute value of said wavenumber K_{D}, such that each wavenumber K_{D} and its associated data is ranked in order of absolute value; and
eliminating FK transformed seismic data that corresponds to those KD values that are not among the highest K_{T} percentage of the K_{D} wavenumber values, wherein K_{T} is one of a plurality of predetermined filter thresholds.

13. The method according to claim 1, further comprising:
iteratively filtering said seismic dataset using a wavenumber threshold K_{T}, such that said wavenumber threshold K_{T} is progressively relaxed for each iteration.

14. A system for reducing jitter in a seismic dataset which contains both original seismic data and other seismic data, the system comprising:
an input device configured to receive the seismic dataset; and
one or more processors configured to filter said seismic dataset to generate a filtered seismic dataset and to re-insert the original seismic data into the filtered seismic dataset to generate a combined seismic data set,
wherein the one or more processors are further configured to repeat the filtering and the re-inserting on said combined dataset.

15. The system of claim 14, wherein the original seismic data is original traces and the other seismic data is interpolated traces.

16. The system of claim 14, wherein the original seismic data is data associated with a first seismic survey of an area and the other seismic data is data associated with a second seismic survey of the same area.

17. The system of claim 14, wherein the original seismic data is data associated with one of a vintage, a survey, an offset class or an azimuth class, and wherein the other seismic data is data associated with a respective one of another vintage, another survey, another offset class or another azimuth class.

18. The system of claim 14, wherein the one or more processors perform the repeating of said filtering and re-inserting a predetermined number of times.

19. The system of claim 14, wherein the one or more processors perform the repeating of the filtering-and re-inserting a variable number of times until the other seismic data fits with the original seismic data when a normalized cross-correlation between said filtered seismic dataset and said original seismic data exceeds a threshold level.

20. The system according to claim 14, wherein the one or more processors are further configured to perform the filtering by:
transforming said seismic dataset from a distance-time (XT) domain to a frequency wavenumber (FK) domain;
creating a dip map by scanning dips in said seismic dataset to create a plurality of wavenumbers K_{D} that respectively correspond to said FK transformed seismic dataset;
using said dip map to eliminate certain FK transformed seismic data on the basis of respective corresponding wavenumbers K_{D}; and
reverse transforming remaining FK transformed seismic data back to said XT domain.

21. The system according to claim 20, wherein said one or more processors are further configured to use said dip map by:
determining a relative value for each wavenumber K_{D} with respect to every other K_{D} wavenumber value, such that there are highest to lowest numbers of wavenumbers K_{D}; and
eliminating FK transformed seismic data that corresponds to those KD values that are not among the highest K_{T} percentage of the K_{D} wavenumber values, wherein K_{T} is one of a plurality of predetermined filter thresholds.

22. The system according to claim 20, wherein said one or more processors are further configured to use said dip map by:
binning each of said wavenumbers K_{D} according to an absolute value of said wavenumber K_{D}, such that each wavenumber K_{D} and its associated data is ranked in order of absolute value; and
eliminating FK transformed seismic data that corresponds to those KD values that are not among the highest K_{T} percentage of the K_{D} wavenumber values, wherein K_{T} is one of a plurality of predetermined filter thresholds.

23. A method for reducing jitter in a seismic dataset which contains both original seismic data and other seismic data, the method comprising:
filtering said seismic dataset to generate a filtered seismic dataset;
re-inserting the original seismic data into the filtered seismic dataset to generate a combined seismic data set; and
repeating said filtering step and said re-inserting step on said combined dataset until said other seismic data fits with said original seismic data,
wherein the step of filtering further comprises:
transforming said seismic dataset from a distance-time (XT) domain to a frequency wavenumber (FK) domain;
creating a dip map by scanning dips in said seismic dataset to create a plurality of wavenumbers K_{D} that respectively correspond to said FK transformed seismic dataset;
using said dip map to eliminate certain FK transformed seismic data on the basis of respective corresponding wavenumbers K_{D}; and
reverse transforming remaining FK transformed seismic data back to said XT domain.
